(19) United States
(12) Patent Application Publication
(10) Pub. No.: US 2008/0194759 A1
(43) Pub. Date: Aug. 14, 2008

(54) Acrylic Block Copolymers as Acoustical and Vibrational Dampening Material for Use in Electronic Devices

(76) Inventor: Daniel J. Casper, Hartford, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/673,138

(22) Filed: Feb. 9, 2007

(51) Int. Cl. C08L 31/00; C08L 33/02

(52) U.S. Cl. 524/556; 525/221

(57) ABSTRACT

An electronic device comprises a pressure sensitive adhesive comprising a block copolymer comprising at least one block of a poly(alkyl(meth)acrylate), e.g., poly(methyl(meth)acrylate), and at least one block of a poly(alkylacrylate), e.g., poly(butylacrylate). The adhesive can further comprise a tackifier, e.g., a rosin ester.

### FIELD OF THE INVENTION

This invention relates to damping noise and vibrations in electronic devices. In one aspect, the invention relates to damping noise and vibrations in hard disk drives while in another aspect, the invention relates to damping noise and vibrations in hard disk drives using a pressure sensitive adhesive (PSA). In still another aspect, the invention relates to the use of certain acrylic block copolymers as an acoustic and vibration damping PSA for use in hard disk drives and other electronic devices.

### BACKGROUND OF TEE INVENTION

Acoustical and vibrational damping continues to play a critical role in the use of hard disk drives and other electronic devices which require or benefit from minimal background noise and/or movement, e.g., speakers and other audio equipment, televisions, electronic analytical equipment and the like. The decreasing form factor and higher aerial densities used in the hard disk drive industry has mandated improved performance for noise and vibration isolation. Current methods use a constrained layer damper in which a visco-elastic component is a conventional acrylic PSA.

Conventional acrylic pressure sensitive adhesives are polymerized by free radical polymerization, and this produces polymers with a broad molecular weight distribution, e.g., typically greater than 3. In order for a PSA to dampen noise and vibration at the typical operating temperature of a hard disk drive, e.g., 70-80 C, the glass transition temperature (Tg) of the PSA must be above this temperature. As a practical matter, this means that the PSA must be hard relative to a similar PSA with a lower Tg and this, in turn, means a PSA with diminished adhesive properties relative to a similar PSA with a lower Tg. If the temperature requirement for the PSA exceeds that of commercially available PSA, then typically a thermoplastic laminating resin is used. However, these materials are non-tacky at room temperature, and thus require heat and pressure to bond to a substrate. In the manufacture of bard disk drives and other sensitive electronic devices, the use of heat and pressure are not always a viable option.

Block copolymers are polymers comprising alternating sections of one chemical composition separated by sections of a different chemical composition or by a coupling group, typically of low molecular weight. The sections are linearly arranged in blocks, and the blocks comprise a portion of the polymer molecule in which the monomeric units have at least one constitutional or configurational feature not present in the adjacent portions of the molecule. In a block copolymer, each of the blocks comprise units derived from a characteristic species of at least one monomer. U.S. Pat. No. 7,067,586 provides a good, general description of block copolymers.

Acrylic block copolymers are known. For example, three published U.S. patent applications by Taniguchi, et al. (US 2005/0085592, 2005/0234199 and 2005/0272865) teach acrylic block copolymers comprising a (meth)acrylic polymer block and an acrylic polymer block. The (meth)acrylic polymer block is copolymerized with a monomer having a functional group such as a carboxyl or anhydride group to improve their heat and oil resistance and other properties for automotive applications. In addition the '592 and '865 applications acknowledge a (meth)acrylic block copolymer including a hard segment of methyl methacrylate and a soft segment of butyl acrylate, but these applications simply identify this block copolymer as thermoplastic elastomer with excellent weather, heat and oil resistance and durability. These applications do not discuss the damping properties of this block copolymer, or its use as a PSA damping material in electronic devices.

Two Japanese patents, i.e., JP 6287253 and JP 8003249, assigned to Kuraray Co. teach the use of styrene-diene block copolymers for vibration damping, but not for use in hard disk drives. Moreover, the use of styrene-diene block copolymers in the manufacture of hard disk drives is disfavored because the industry has a long history of using acrylic-based PSA and the introduction of PSA based on other monomers complicates the manufacturing process due to qualification, compatibility and performance issues.

Other references disclosing compositions with damping properties include two Japanese patents, i.e., JP 8259769 and JP 9031296, assigned to Japan Synthetic Rubber (rubber-modified thermoplastic compositions); two Japanese published patent applications, i.e., JP 2003321524 and JP 2004143340, assigned to Kanegafuchi Chemical (block copolymers comprising a methacrylic polymer block and an acrylic polymer block but not in a PSA and not for use in a hard disk drive); one Japanese patent, i.e., JP 11080494, assigned to Denki Kagaku Kogyo (styrene/conjugated diene block copolymer for use as a cover film); and one Japanese published patent application, i.e., JP 2002201244, assigned to Nippon Catalytic Chemical Industry (an acrylic block copolymer in combination with a polyvalent mercaptan compound). In addition, U.S. Pat. No. 6,329,480 teaches the synthesis of an acrylic block copolymer using an organo-aluminum catalyst.

Due to the ever increasing demand in the hard disk drive industry for improved PSA with acoustical and vibrational damping properties, a continual need exists for visco-elastic materials with improved damping performance at elevated temperatures but with acceptable behavior as a PSA at room temperatures.

### SUMMARY OF THE INVENTION

In one embodiment of this invention, an electronic device comprises a pressure sensitive adhesive comprising a block copolymer comprising at least one block of a poly(alkyl(meth)acrylate), e.g., poly(methyl(meth)acrylate) (PMMA), and at least one block of a poly(alkylacrylate), e.g., poly(butylacrylate) (PBA). Due to the block design and the difference in Tg of the different blocks, egg., the Tg of PMMA is 105 C and the Tg of PBA is −49 C (literature values of homopolymers), the block copolymer separates into two separate domains. In a preferred embodiment, the PSA used in the practice of this invention is preferably free of any significant amount of acrylic acid. In another embodiment the block copolymers used in the practice of this invention are mixed with a tackifier, e.g., a rosin ester, to enhance room temperature adhesive performance.

The block copolymers used in the practice of this invention allows for improved acoustical and vibrational damping performance in electronic devices, as compared with the conventional PSA in commercial use today, at both elevated and room temperatures. Moreover, the lack of acrylic acid is advantageous for the hard disk drive industry because acrylic acid is typically added to conventional acrylic-based PSA to improve tack and increase Tg. Furthermore, acrylic acid is a concern for hard disk drive manufacturers because it has the ability to condense inside and contaminate the hard drive, thus impacting the performance of the drive.

### BRIEF DESCRIPTION OF THE DRAWINGS

FIG. 1 is a graph reporting the dampening performance of a traditional acrylic hard disk drive (HDD) adhesive.

FIG. 2 is a graph reporting the dampening performance of an acrylic block copolymer adhesive of this invention.

FIG. 3 is a graph reporting the impact of a rosin ester tackifier on the am delta peak temperature of a PMMA-PBA-PMMA block copolymer adhesive.

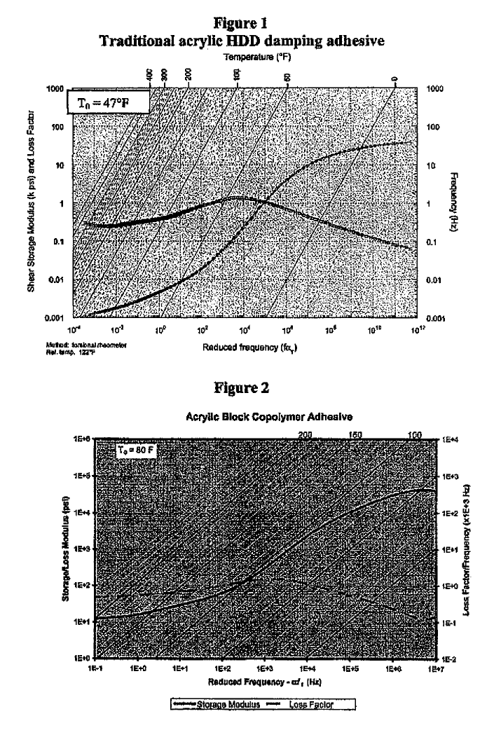

### DETAIL DESCRIPTION OF THE PREFERRED EMBODIMENTS

The block copolymers used in the practice of this invention are known materials and are prepared by known processes. Alkyl(meth)acrylate monomers that can be used in the preparation of the poly(alkyl(meth)acrylate) blocks (also referred to in this specification as “A” blocks) include, but are not limited to, methyl(meth)acrylate, ethyl(meth)acrylate, n-propyl(meth)acrylate, isopropyl(meth)acrylate, n-butyl(meth)acrylate, iso-butyl(meth)acrylate, t-butyl(meth)acrylate, n-pentyl(meth)acrylate, n-hexyl(meth)acrylate, cyclohexyl(meth)acrylate, n-heptyl(meth)acrylate, noctyl(meth)acrylate, 2-ethylhexyl(meth)acrylate, n-nonyl(meth)acrylate, n-decyl(meth)acrylate, n-dodecyl(meth)acrylate, phenyl(meth)acrylate, toluyl(meth)acrylate, benzyl(meth)acrylate, 2-methoxyethyl(meth)acrylate, 3-methoxyethyl(meth)acrylate, 2-hydroxyethyl(meth)acrylate, 2-hydroxypropyl(meth)acrylate and the like. These monomers can be used alone or in combinations of two or more monomers. Preferred alkyl(meth)acrylate monomers are C₁₋₁₀ alkyl(meth)acrylate monomers, more preferably C₁₋₄ alkyl(meth)acrylate monomers and most preferably methyl(meth)acrylate. As here used and as illustrated above, “alkyl(meth)acrylate” includes (meth)acrylates that have a substituent other than an alkyl, e.g., phenyl, benzyl, alkyloxy, etc.

The alkyl acrylate monomers that can be used in the preparation of the poly(alkyl)acrylate blocks (also referred to in this specification as “B” blocks) include but are not limited to methyl acrylate, ethyl acrylate, n-propyl acrylate, isopropyl acrylate, n-butyl acrylate, iso-butyl acrylate, t-butyl acrylate, n-pentyl acrylate, n-hexyl acrylate, cyclohexyl acrylate, n-heptyl acrylate, n-octyl acrylate, 2-ethylhexyl acrylate, n-nonyl acrylate, n-decyl acrylate, n-dodecyl acrylate, phenyl acrylate, toluyl acrylate, benzyl acrylate, 2-methoxyethyl acrylate, 3-methoxyethyl acrylate, 2-hydroxyethyl acrylate, 2-hydroxypropyl acrylate and the like. These monomers can be used alone or in combinations of two or more monomers. Preferred alkyl acrylate monomers are C₁₋₁₀ alkyl acrylate monomers, more preferably C₁₋₄alkyl acrylate monomers and most preferably n-butyl acrylate. As here used and as illustrated above, “alkyl acrylate” includes acrylates that have a substituent other than an alkyl, e.g., phenyl, benzyl, alkyloxy, etc.

The block copolymers used in the practice of this invention are prepared in a known manner, typically by a living or controlled-type, free-radical polymerization of the alkyl(meth)acrylate and alkyl acrylate monomers. In some embodiments, sequential addition of different monomers or monomer mixtures is used while in other embodiments, a “pre-assembled” polymer block is added to a living, free-radical polymerization mixture. Customary polymerization techniques include suspension, emulsion and solution polymerizations. The polymerization can be conducted in bulk or in a solvent, and at a typical temperature of ambient to about 200 C, more typically from about 50 to about 150 C.

The Tg of the poly(alkyl(meth)acrylate) block or blocks is typically from about 100 to about 160 C, preferably from about 110 to about 150 C and more preferably from about 130 to about 140C. The Tg of the poly(alkyl)acrylate block or blocks is typically from about −100 to about 10 C, preferably from about −55 to about −15 C and more preferably from about −40 to about −25 C. The difference between the Tg of the poly(alkyl(meth)acrylate) block and the poly(alkyl)acrylate block is typically between about 100 to about 225 C, preferably from about 125 to about 225 C and more preferably from about 150 to about 200 C. The Tg value for any particular block will depend, of course, on the overall nature of the polymer and the identity of the particular block. For purposes of this invention, the poly(alkyl(meth)acrylate) or A block is the hard block, and the poly(alkyl) acrylate or B block is the soft block. Tg can be measured by a variety of well-known, standard techniques. One common procedure is by dynamic mechanical analysis (DMA).

The poly(alkyl(meth)acrylate) blocks typically have a number average molecular weight (Mn) of from about 5,000 to about 15,000 grams per mole (g/mol), preferably from about 6,000 to about 10,000 g/mol and more preferably from about 7,000 to about 9,000 g/mol.

The Mn of both the A and B blocks and the block copolymer typically have a number average molecular weight (M) of from about 60,000 to about 120,000 grams per mole (g/mol), preferably from about 75,000 to about 105,000 g/mol and more preferably from about 85,000 to about 95,000 g/mol. The Mn of both the A and B blocks and the block copolymer itself are typically measured by the procedure of ASTM D5296-05.

The block copolymers used in the practice of this invention comprise at least one poly(alkyl(meth)acrylate) block and at least one poly(alkylacrylate) block, but typically comprise two poly(alkyl(meth)acrylate) blocks separated by one poly(alkylacrylate) block, i.e., an A-B-A configuration. The block copolymers used in the practice of this invention can also comprise multiple blocks of poly(alkyl(meth)acrylate) and,poly(alkylacrylate) each separated by the other. The molar ratio of poly(alkyl(meth)acrylate) block to poly(alkylacrylate) block is typically from about 1:10 to about 10:1, preferably from about 1:10 to about 2.5:10.

Generally, different applications will require or prefer different relative sizes of the poly(alkyl(meth)acrylate) block to the poly(alkylacrylate) block. In some instances the blocks will be of comparable size while in other instances, the blocks will be of vastly different sizes. Usually, the blocks are of comparable size, e.g., the poly(alkyl(meth)acrylate) block will be within 6-25 weight percent of the Mn of the poly(alkylacrylate) block.

The Mn of the block copolymers used in the practice of this invention can also vary widely, but typically it is between about 40,000 and about 150,000 g/mol with the understanding that the only limits on the minimum and maximum Mn are those set by practical considerations, e.g., processability both in manufacture and application, cost, etc. Preferably die minimum Mn is at least about 60,000, more preferably at least about 75,000 and even more preferably at least about 85,000, g/mol. Preferably the maximum Mn does not exceed about 120,000, more preferably does not exceed about 105,000 and even more preferably does not exceed about 95,000, g/mol.

The polydispersity or molecular weight distribution (MWD or Mw/Mn) of the block copolymers used in the practice of this invention is typically between about 1 and about 2, preferably between about 1.1 and about 1.5 and more preferably between about 1.2 and about 1.4.

The block copolymers used in the practice of this invention can be used neat or blended with other materials, most notably one or more tackifiers to increase the tackiness of the copolymer at room temperature. Generally, the hinder the block copolymer, the less tacky it is at room temperature and the more it benefits from the addition of a tackifier, e.g., rosin esters, aromatic resins, hydrogenated rosin esters, hydrocarbon resins and hydrogenated aromatic resins. The optimum amount of tackifier that can be admixed with the block copolymer will vary with the composition of block copolymer, the composition of the tackifier, the presence or absence of other additives, the conditions of use, and the like, and this amount is well within the skill of the ordinary artisan to determine. Other additives that can be formulated with the block copolymer include antioxidants, plasticizers, UV-inhibitors, pigments, fillers, processing aids and the like.

One exemplary block copolymer of this invention is the LA series of copolymers available from Kuraray Co., Ltd. of Japan, e.g., LA 2140e and LA 1114. This series of copolymers comprises two blocks of poly(methyl(meth)acrylate) separated by a block of poly(n-butylacrylate), i.e., PMMA-PBA-PMMA. As reported by Kuraray, the Pg of the PA block is about 150 C, and the Tg of tie PBA block is about −35 C. In one embodiment, this block copolymer is tackified with a diblock copolymer of PMMA and PBA, i.e., PMMA-PBA.

One defining characteristic of the block copolymers used in the practice of this invention is their functionality as a PSA at room temperature, with or without the addition of a tackifier, in addition to their stability at relatively high temperatures, e.g., in excess of 50 C, preferably in excess of 60 C and even more preferably in excess of 70 C. Moreover, these block copolymers are free of any significant amounts of acrylic acid, a common additive to many conventional acrylic-based PSA to improve tack under ambient conditions and to increase Tg (and thus stability at elevated temperatures). By “significant amounts” is meant that any acrylic acid that is present has little, if any, effect on the tack and Tg of the block copolymer. Typically and preferably, acrylic acid is not added to the block copolymers and any present is simply present as an impurity, e.g., residue left from the manufacture of the acrylate monomers used in the manufacture of the block copolymers.

The poly(alkyl(meth)acrylate)/poly(alkylacrylate) block copolymers of this invention are used in the same manner and in the same amount as are conventional PSA for the manufacture of hard disk drives and other electronic devices. These other devices include speakers and other audio equipment, televisions, electrical analytical equipment (e.g., oscilloscopes), medical monitoring equipment and the like.

The ability of a polymer to dampen vibrations is a function of its visco-elastic properties. More specifically, the maximum loss factor corresponds to the peak of the tan delta (δ) curve (an index of the vibration damping property of a material) from a dynamic mechanical analysis curve.

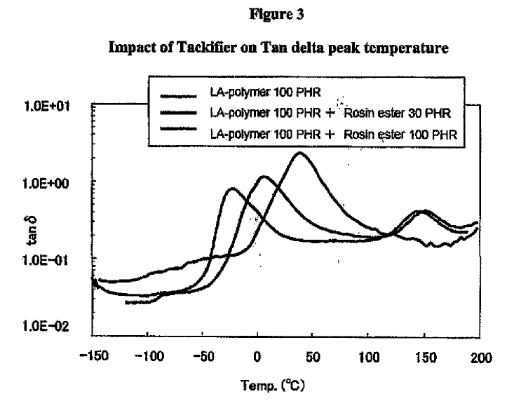

FIG. 1 reports that the dampening peak of a traditional hard disk drive (HDD) acrylic acid PSA is at 47 F (8 C), while the acrylic block copolymer adhesive of this invention has its dampening peak at 80 F (27 C). FIG. 3 shows that manipulation of tan delta, and therefore the loss factor, can be changed by the addition of tackifiers (here, the rosin ester). FIG. 3 also shows that the polybutyl acrylate domain of the LA-polymer associates with the rosin ester tackifier shifting the tan delta to higher temperatures. However, at excessive tackifier loadings (here, 100 parts per hundred resin or phr of rosin ester), the tackifier is no longer isolated to the polybutyl acrylate domain and is observed in the loss of the PMMA peak (the second “peak” of this curve is a valley).

Although the invention has been described in considerable detail through the preceding embodiments, this detail is for the purpose of illustration. Many variations and modifications can be made upon this description without departing from to spirit and scope of the invention as it is described in the following, claims. All U.S. patents and published patent applications identified above are incorporated herein by reference.

What is claimed is:

1. An electronic device comprising an acoustical and vibrational damping pressure sensitive adhesive (PSA), the PSA comprising a block copolymer comprising at least one block of a poly(alkyl(meth)acrylate) and at least one block of a poly(alkyl)acrylate.

2. The device of claim 1 in which the poly(alkyl(meth)acrylate) is a poly(C₁₋₁₀ alkyl(meth)acrylate) and the poly(alkyl)acrylate is a poly(C₁₋₁₀ alkyl)acrylate.

3. The device of claim 1 in which the poly(alkyl(meth)acrylate) is poly(methyl(meth)acrylate) and the poly(alkyl)acrylate is poly(n-butyl)acrylate.

4. The device of claim 1 in which the block copolymer has a polydispersity of between about 1 and about 2.

5. The device of claim 1 in which the block copolymer is free of any significant amount of acrylic acid.

6. The device of claim 1 in which the block copolymer comprises two blocks of poly(alkyl(meth)acrylate) separated by one block of poly(alkyl)acrylate.

7. The device of claim 1 in which the block copolymer is formulated with a tackifier.

8. The device of claim 7 in which the tackifier is a rosin ester.

9. The device of claim 7 in which the block copolymer comprises two blocks of poly(alkyl(meth)acrylate) separated by one block of poly(alkyl)acrylate, and the tackifier is a block copolymer comprising one block of poly(alkyl(meth)acrylate) and one block of poly(alkyl)acrylate.

10. The device of claim 1 in the form of a hard disk drive.
